(19) United States
(12) Patent Application Publication
(10) Pub. No.: US 2010/0300977 A1
(43) Pub. Date: Dec. 2, 2010

(54) OPERATIONS OF SELENIUM REMOVAL SORBENT BEDS

(75) Inventors: Mark A. Hughes, Bartlesville, OK (US); Steven C. Mitchell, Lafayette, CA (US)

Correspondence Address: ConocoPhillips Company - IP Services Group;Attention: DOCKETING, 600 N. Dairy Ashford, Bldg. MA-1135, Houston, TX, 77079, US

(73) Assignee: ConocoPhillips Company, Houston, TX (US)

(21) Appl. No.: 12/786,507

(22) Filed: May 25, 2010

Related U.S. Application Data
(60) Provisional application No. 61/181,482, filed on May 27, 2009.

(51) Int. Cl. C02F 1/42; B01D 24/46

(52) U.S. Cl. 210/670; 210/177; 210/106

(57) ABSTRACT

Methods and apparatus relate to removing selenium from a fluid. The fluid includes non-selenium constituents that are insoluble at a pH in which the fluid is passed through a sorbent bed in order to remove the selenium. Fouling of the sorbent bed can thereby result due to accumulation of the non-selenium constituents, which are precipitated solid materials. Intermittent washing of the sorbent bed with a heated and alkaline wash dissolves and removes the non-selenium constituents to maintain efficient operation and sustain selenium removal performance.

### CROSS-REFERENCE TO RELATED APPLICATIONS

None

### STATEMENT REGARDING FEDERALLY SPONSORED RESEARCH OR DEVELOPMENT

None

### FIELD OF THE INVENTION

Embodiments of the invention relate to removing selenium from fluids.

### BACKGROUND OF THE INVENTION

Fossil fuels contain naturally occurring selenium. Refining of oils and processing of coals containing selenium can generate process water with amounts of selenium-containing compounds in excess of limits allowed by governmental standards for discharge of the water into the environment. One treatment technique for the process water relies on adsorption. However, lifetime of selenium removal sorbent beds can influence economic viability of such techniques.

Therefore, a need exists for improved methods and systems for removing selenium from fluids.

### SUMMARY OF THE INVENTION

In one embodiment, a method of removing selenium from an acidic aqueous fluid includes removing the selenium by contacting the acidic aqueous fluid with a sorbent for the selenium. Further, washing the sorbent with an alkaline fluid occurs at a temperature above 35° C. to dissolve and remove solid constituents that are from the acidic aqueous fluid and accumulate within a bed formed of the sorbent. The method also includes alternating flow through the bed between the acidic aqueous fluid for the removing of the selenium and the alkaline fluid for the washing of the sorbent.

According to one embodiment, a system for removing selenium from an acidic aqueous fluid includes a selenium-containing acidic aqueous fluid supply, an alkaline fluid supply, and a heater having a heated alkaline fluid output by being coupled to supply heat to the alkaline fluid supply. A selenium removal assembly of the system includes a sorbent for selenium. In addition, the system includes a flow control device operable to alternate fluid communication with the selenium removal assembly between the acidic aqueous fluid supply and the heated alkaline fluid output.

For one embodiment, a method includes passing an aqueous liquid containing selenium into contact with a sorbent for selenium to remove the selenium from the aqueous liquid and passing a wash fluid through a bed formed of the sorbent to remove accumulation of organic compounds that are solids precipitated by the aqueous liquid being acidified. Acidifying the aqueous liquid facilitates removing the selenium. Further, making the wash fluid alkaline and heating the wash fluid facilitates dissolving and removal of the organic compounds from the bed.

### BRIEF DESCRIPTION OF THE DRAWINGS

The invention, together with further advantages thereof, may best be understood by reference to the following description taken in conjunction with the accompanying drawings.

FIG. 1 is a schematic of a system for removing selenium from an aqueous fluid, according to one embodiment of the invention.

FIG. 2 is a flow chart illustrating a method of removing selenium from an aqueous fluid, according to one embodiment of the invention.

### DETAILED DESCRIPTION OF THE INVENTION

Embodiments of the invention relate to removing selenium from a fluid. As used herein, “selenium” refers to selenium within or from compounds, such as selenocyanate, selenite, selenate, hydrogen selenide, and combinations thereof, containing selenium and at least one other element and/or elemental selenium. The fluid includes non-selenium constituents that are insoluble at a pH in which the fluid is passed through a sorbent bed in order to remove the selenium. Fouling of the sorbent bed can thereby result due to accumulation of the non-selenium constituents, which are precipitated solid materials. Intermittent washing of the sorbent bed with a heated and alkaline wash dissolves and removes the non-selenium constituents to maintain efficient operation and sustain selenium removal performance.

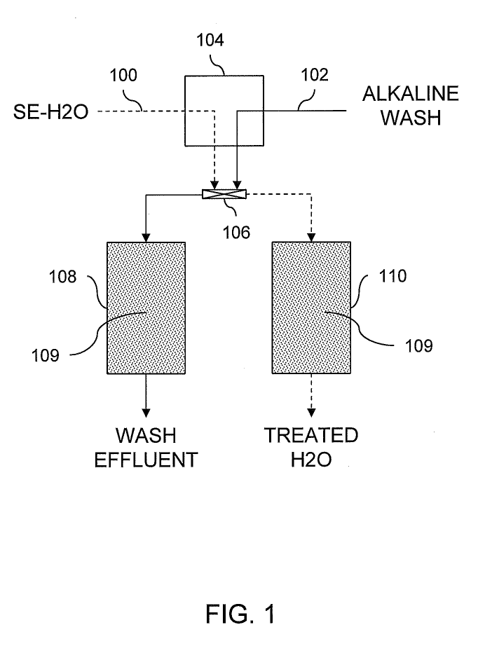

FIG. 1 illustrates a schematic of an exemplary system for removing selenium from an aqueous fluid. The system defines a treatment flow path 100 (represented by a dashed line) and a purge flow path 102 (depicted as a solid line) and includes a heater 104, a flow control device, such as a valve 106, a first reactor 108 and a second reactor 110. In operation, a selenium-containing fluid enters the system and passes through the treatment flow path 100 prior to exiting the system as treated fluid due to sorption of the selenium by sorbent 109 within one of the reactors 108, 110.

The valve 106 diverts the treatment flow path 100 to either the second reactor 110 as shown or the first reactor 108 and directs the purge flow path 102 to either the first reactor 108 as shown or the second reactor 110. While only one of the reactors 108, 110 is needed in some embodiments for batch treating of the selenium-containing fluid, the system may utilize the first and second reactors 108, 110 in a swing arrangement such that while the treatment flow path 100 passes through one of the reactors 108, 110 the purge flow path 102 passes through another one of the reactors 108, 110, which is thereby being purged and readied for reuse to remove the selenium from the selenium-containing fluid once the treatment and purge flow paths 100, 102 are switched back. Alternating the treatment flow path 100 and the purge flow path 102 between respective ones of the reactors 108, 110 enables continuous stripping of the selenium from the selenium-containing fluid. While respective flow paths change with time between status states, operational details of the states correspond such that operation of the system as described herein refers to the state of the reactors 108, 110 as depicted.

For some embodiments, the selenium-containing fluid feeding into the treatment flow path 100 is aqueous and contains water with the selenium along with other inorganic and organic constituents. Inside the second reactor 110, the selenium-containing fluid contacts the sorbent 109, which may be formed of a supported sulfur material, such as a sulfur impregnated carbon, silica, and/or alumina support. The treated fluid that is output from the second reactor 110 contains less selenium and has a lower selenium concentration than the selenium-containing fluid input into the second reactor 110.

The selenium-containing fluid may further be acidic or be made acidic by adding an acid to the selenium-containing fluid to adjust pH of the selenium-containing fluid. Depending on initial temperature of the selenium-containing fluid, the heater 104 may increase temperature of the selenium-containing fluid prior to introduction of the selenium-containing fluid into the second reactor 110. Regulating temperature and pH of the selenium-containing fluid enables meeting operational pH and temperature requirements for removal of the selenium with the sorbent 109. For example, the selenium-containing fluid may be at a pH between about 2 and about 5 to achieve desired removal of the selenium.

At such acidic pH, the organic compounds that may include naphthenic acids within the selenium-containing fluid tend to precipitate out of solution. The organic compounds that are thus solid materials accumulate on a bed of the sorbent 109 in the second reactor 110 as the selenium-containing fluid passes through the second reactor 110. Accumulation of the organic compounds can result in increasing over time backpressure generated by the bed of the sorbent 109 in the second reactor 110.

To maintain a flow rate of the selenium-containing fluid through the second reactor 110, the increase in backpressure requires the selenium-containing fluid be introduced into the second reactor 110 at higher pressures that may not be attainable. As the selenium-containing fluid flows through the second reactor 110, selenium removal performance can hence diminish due to the organic compounds that accumulate causing issues such as the increase in the backpressure or interference with contact of the selenium-containing fluid with the sorbent 109. Premature deactivation of the sorbent 109 in the second reactor 110 can occur without purging of the second reactor 110 to dissolve and remove the solid material. Avoiding premature deactivation with the purging prevents expense and complexity of unnecessary sorbent change-outs and associated cost for quantity of sorbent used.

The purge flow path 102 passing through the first reactor 108 exemplifies the purging of the first reactor 108 analogous to the purging employed with the second reactor 110. Switching the treatment flow path 100 and the purge flow path 102 between respective ones of the reactors 108, 110 may occur at any time or based on switch criteria including set intervals, when a flow rate of the selenium-containing fluid reaches a flow rate threshold, or when rate of selenium removal from the selenium-containing fluid reaches a removal threshold. For some embodiments, settings trigger automatic actuation of the valve 106 to alternate fluid communication of the treatment flow path 100 and the purge flow path 102 between respective ones of the reactors 108, 110 based on the switch criteria.

An alkaline wash passes through the purge flow path 102 and in some embodiments is aqueous and at a pH of above 7 and below about 11, between about 7.5 and about 9.0, or about 8.5. In some embodiments, the alkaline wash includes any base (e.g., an alkali metal hydroxide) or is prepared by adding the base to water. The heater 104 increases temperature of the alkaline wash to above 35° C., between about 70° C. and about 95° C., or about 82° C. prior to the alkaline wash entering the first reactor 108. The alkaline wash passes through the bed of the sorbent 109 in the first reactor 108 while still heated to such temperatures. The alkaline wash may pass through the first reactor 108 in a backward or forward direction relative to a flow direction of the selenium-containing fluid since the alkaline wash does not rely on changing flow movement to purge the first reactor 108. In some embodiments, the heater 104 brings the alkaline wash and the selenium-containing fluid to a common temperature or within about 15° C. of one another since temperatures suitable for removing selenium may also be suitable for washing the sorbent 109 without causing a change in temperature in the reactors 108, 110.

The temperature and pH of the alkaline wash determine decomposition rate of the organic compounds that accumulate such that the temperature and pH selected for the alkaline wash depend on properties of the organic compounds and enable sufficient dissolving and removal of the organic compounds from a bed of the sorbent 109 within the first reactor 108. While the temperature and the pH of the alkaline wash facilitate the dissolving of the organic compounds, the sorbent 109 retains the selenium even after passing the alkaline wash in contact with the sorbent 109. Since the sorbent 109 retains the selenium until the sorbent 109 is replaced or regenerated, the sorbent 109 retains the selenium through multiple cycles of alternating the treatment flow path 100 and the purge flow path 102 through each of the reactors 108, 110.

Amount of time needed to purge the first reactor 108 with the alkaline wash to make the first reactor 108 ready to be used for removing selenium from the selenium-containing fluid depends on size of the first reactor 108 and magnitude of the backpressure. For some embodiments, the alkaline wash passes through the first reactor 108 for a period of 1 to 100 hours or about 24 hours to about 48 hours. Hydraulic loading for the alkaline wash may range from 40 liter per minute per square meter (LPM/m²) to 400 LPM/m² or from 81 LPM/m² to 245 LPM/m².

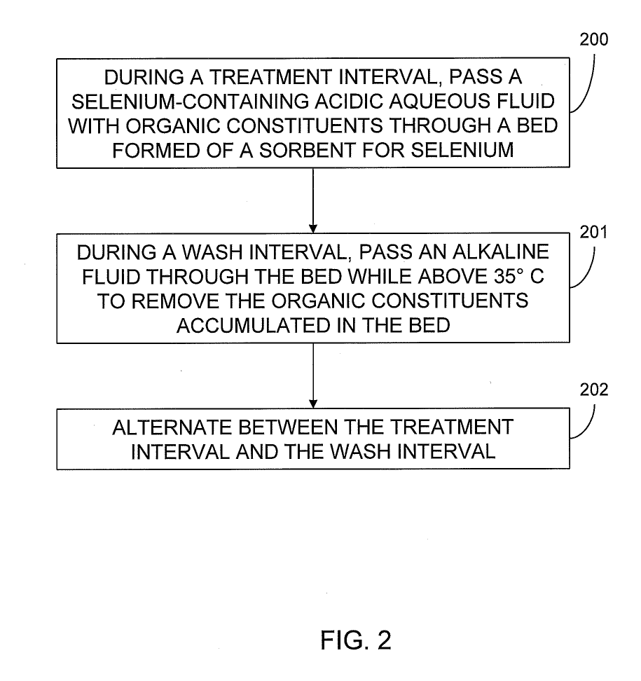

FIG. 2 shows a flow chart illustrating a method of removing selenium from an aqueous fluid. In a decontamination step 200, a selenium-containing acidic aqueous fluid passes through a bed formed of a sorbent for selenium. The sorbent throughout a treatment interval in the decontamination step 200 removes the selenium from the selenium-containing acidic aqueous fluid. The selenium-containing acidic aqueous fluid further includes organic constituents.

A purge step 201 defines a wash interval independent of the treatment interval with respect to the bed formed of the sorbent. An alkaline fluid passes through the bed while above 35° C. during the wash interval in the purge step 201. The alkaline fluid used in the purge step 201 removes the organic constituents accumulated in the bed. Repetition step 202 cycles between the treatment interval and the wash interval. The decontamination step 200 and the purge step 201 thus may repeat multiple times prior to change-out of the sorbent.

### Example

Four selenium removal beds with sorbent made of sulfur impregnated activated carbon were used in a selenium removal process. The beds were fed with an influent of test water containing selenium and phenolic compounds. Sulfuric acid added to the test water adjusted pH of the test water to 2.5 prior to being fed through the beds. In addition, the test water was heated in order to contact the sorbent between 71° C. and 77° C. Flow rate of the test water was controlled at 1.5 liters per minute (LPM). Input pressure for the test water fluctuated between 138 kilopascal (kPa) and 207 kPa. A backpressure from the beds increased with time and was sufficient within five days to prevent maintaining the 1.5 LPM flow rate with the input pressure.

The feed of the test water to the beds was then stopped and substituted for flush water. The flush water fed to the beds at a flow rate of 2.8 LPM for a time period of 24 hours was at a pH of 7.5 to 8.5 and was heated to 82° C. After the 24 hours, the flush water was stopped and the test water was diverted back to the beds. Use of the flush water enabled the flow rate of the test water to be returned to 1.5 LPM. No selenium was detected in effluent of the flush water utilized during the 24 hours. Cycling between the test water and the flush water was repeated an additional four times each time the flow rate of the test water dropped below 1.1 LPM. The test water was able to be fed through the beds at the 1.5 LPM flow rate at start of the test water in each cycle.

The preferred embodiment of the present invention has been disclosed and illustrated. However, the invention is intended to be as broad as defined in the claims below. Those skilled in the art may be able to study the preferred embodiments and identify other ways to practice the invention that are not exactly as described herein. It is the intent of the inventors that variations and equivalents of the invention are within the scope of the claims below and the description, abstract and drawings are not to be used to limit the scope of the invention.

1. A method comprising:
removing selenium from an acidic aqueous fluid by contacting the acidic aqueous fluid with a sorbent for the selenium, wherein the acidic aqueous fluid contains solid constituents;
washing the sorbent with an alkaline fluid, wherein the washing occurs at a temperature above 35° C. to dissolve and remove the solid constituents accumulated within a bed formed of the sorbent; and
alternating flow through the bed between the acidic aqueous fluid for the removing of the selenium and the alkaline fluid for the washing of the sorbent.

2. The method according to claim 1, wherein the solid constituents include organic compounds.

3. The method according to claim 1, wherein the solid constituents include naphthenic acids.

4. The method according to claim 1, wherein the sorbent comprises sulfur impregnated support material.

5. The method according to claim 1, wherein the alternating includes switching the flow through the bed from the acidic aqueous fluid to the alkaline fluid when one of (i) a flow rate of the acidic aqueous fluid reaches a threshold and (ii) rate of selenium removal from the acidic aqueous fluid reaches a threshold.

6. The method according to claim 1, further comprising heating the alkaline fluid such that the washing occurs at a temperature between 70° C. and 95° C.

7. The method according to claim 1, wherein the alkaline fluid is at a pH above 7 and below 11.

8. The method according to claim 1, wherein alternating flow through the bed includes alternating between passing the acidic aqueous fluid through a first reactor with the bed of the sorbent and flowing the acidic aqueous fluid through a second reactor capable of removing selenium from the acidic aqueous fluid.

9. The method according to claim 1, wherein the sorbent retains the selenium while washing the sorbent with the alkaline fluid.

10. The method according to claim 1, wherein the sorbent retains the selenium through multiple cycles of alternating the flow through the bed between the acidic aqueous fluid and the alkaline fluid.

11. A system comprising:
a selenium-containing acidic aqueous fluid supply;
an alkaline fluid supply;
a heater having a heated alkaline fluid output by being coupled to supply heat to the alkaline fluid supply;
a selenium removal assembly that includes a sorbent for selenium; and
a flow control device operable to alternate fluid communication with the selenium removal assembly between the acidic aqueous fluid supply and the heated alkaline fluid output.

12. The system according to claim 11, wherein the sorbent comprises sulfur impregnated support material.

13. The system according to claim 11, wherein constituents defining the selenium-containing acidic aqueous fluid supply include organic compounds dissolvable by flow from the heated alkaline fluid output.

14. The system according to claim 11, wherein constituents defining the selenium-containing acidic aqueous fluid supply include naphthenic acids.

15. The system according to claim 11, wherein the flow control device is set to switch the fluid communication with the selenium removal assembly from the selenium-containing acidic aqueous fluid supply to the heated alkaline fluid output when a flow rate through the selenium removal assembly reaches a threshold.

16. A method comprising:
passing an aqueous liquid containing selenium into contact with a sorbent for selenium to remove the selenium from the aqueous liquid, wherein the aqueous liquid is acidified to facilitate removing the selenium; and
passing a wash fluid through a bed formed of the sorbent to remove accumulation of organic compounds that are solids precipitated by the aqueous liquid being acidified, wherein the wash fluid is made alkaline and heated to facilitate dissolving and removal of the organic compounds from the bed.

17. The method according to claim 16, further comprising alternating between the passing of the aqueous liquid into contact with the sorbent and the passing of the wash fluid through the bed formed of the sorbent.

18. The method according to claim 16, wherein the wash fluid is heated between 70° C. and 95° C. and is at a pH between 7.5 and 9.0.

19. The method according to claim 16, wherein the aqueous liquid is at a pH between 2 and 5.

20. The method according to claim 16, wherein the wash fluid and aqueous liquid are heated to within 15° C. of one another.
